(19) United States
(12) Patent Application Publication
(10) Pub. No.: US 2015/0096418 A1
(43) Pub. Date: Apr. 9, 2015

(54) APPARATUS AND METHOD FOR OPERATING A POWER SAW

(71) Applicant: Vito Peter Brancaccio, Innisfil (CA)

(72) Inventor: Vito Peter Brancaccio, Innisfil (CA)

(21) Appl. No.: 14/555,795

(22) Filed: Nov. 28, 2014

Related U.S. Application Data
(63) Continuation-in-part of application No. 14/248,418, filed on Apr. 9, 2014.
(60) Provisional application No. 61/887,928, filed on Oct. 7, 2013.

(51) Int. Cl. B27B 17/00

(52) U.S. Cl. CPC B27B 17/0083
USPC 83/745; 29/434

(57) ABSTRACT

An apparatus for operating a power saw includes a body for supporting the power saw. The body includes a primary coupling mechanism for coupling the power saw to the body and constraining movement of a blade of the power saw to be in a plane. The apparatus further includes a clamping mechanism connected to the body. The clamping mechanism is for clamping a top rail of the fence to secure the body relative to the fence, so that the power saw can be rotated to sweep its blade within the plane to efficiently trim the tops of fence posts.

### FIELD

The present invention relates generally to an apparatus for use with a power saw, and more specifically relates to an apparatus for use with a power saw capable of cutting a fence post.

### BACKGROUND

Fences are generally constructed to divide portions of land. There have been numerous methods and designs for building fences. One example involves erecting fence posts spaced apart from each other and connecting the fence posts with top rails. Fencing material, such as netting, wire-mesh, chain-link, and panels can be suspended from the top rail to the ground to form a barrier.

In general, fence posts are often pre-cut in a factory, such as a lumber mill, to have a uniform length prior to arriving at a worksite where the fence post is to be erected. However, due to variations in ground height as well as variations in posthole depth, the tops of the erected fence posts on a piece of land may not be at the desired heights.

Power saws, such as chainsaws and circular saws, can be used to cut fence posts to the desired heights. For example, the height of the fence post relative to either the ground or the top rail can be measured. A fence builder can use the power saw to cut each fence post to be the same height or cut to follow a slope or pattern by holding the blade of a power saw against the fence post to cut through. By positioning and holding the power saw by hand, undesirable variations can be introduced as the fence builder may not be able to execute a straight cut or a level cut of the fence post. Moreover, certain types of post caps may not fit properly on uneven cuts. In addition, each fence post would need to be manually measured and marked prior to each cut.

### SUMMARY

In accordance with an aspect of the specification, there is provided an apparatus for operating a power saw on a fence. The apparatus includes a body for supporting the power saw. The body includes a primary coupling mechanism for coupling the power saw to the body and constraining movement of a blade of the power saw to be in a plane. The apparatus further includes a clamping mechanism connected to the body. The clamping mechanism is for clamping a top rail of the fence to secure the body relative to the fence.

The primary coupling mechanism may couple the power saw to the body pivotally. The power saw may be rotatable about a primary axis when coupled.

The primary coupling mechanism may include a primary coupling aperture for receiving a coupling member. The coupling member may be for securing the power saw to the body.

The coupling member may include a saw-attaching portion and an anchoring portion. The saw-attaching is for fixing to the power saw and the anchoring portion is for being received in the primary coupling aperture. The saw-attaching portion is rotatably connected to the anchoring portion.

The coupling member may be freely rotatable within the primary coupling aperture such that the power saw is rotatable relative to the body.

The primary coupling mechanism may further include a primary motion limiting aperture for receiving a motion limiting member connected to the power saw. The motion limiting member may be configured to limit the movement of the blade of the power saw by engaging the motion limiting aperture.

The primary coupling mechanism may be disposed proximate to a center point of the body.

The apparatus may further include a secondary coupling mechanism for pivotally coupling the power saw to the body. The power saw may be rotatable about a secondary axis when coupled.

The primary axis may be parallel to the secondary axis.

The secondary coupling mechanism may be offset from the center point of the body. The secondary coupling mechanism may be for coupling the power saw to position the blade for decorative cuts on a side of a fence post.

The primary coupling mechanism may include an arm having a first end and a second end. The first end may be connected to the body and the second end may be connected to the power saw.

The first end may be rotatably connected to the body about a first axis.

The second end may be rotatably connected to the power saw about a second axis.

The clamping mechanism may include a first plate and a second plate. The first plate may be for engaging a first side of the top rail. The second plate may be for engaging a second side of the top rail. The second side may be opposite the first side.

The first plate may be adjusted using a first bolt. The second plate may be adjusted using a second bolt.

The first plate may include a first notch. The second plate may include a second notch. The first notch and second notch may be configured to mate with the body for guiding the movement of the first plate and the second plate relative to the body.

In accordance with another aspect of the specification, there is provided a method of operating a power saw on a fence. The method involves clamping a body to a top rail using a clamping mechanism connected to the body, wherein clamping secures the body relative to the fence. In addition, the method involves coupling the power saw to the body using a coupling mechanism. The method further involves constraining movement of a blade of the power saw to be in a plane.

Coupling the power saw to the body may involve pivotally coupling the power saw to the body, wherein the power saw is rotatable about a primary axis when coupled.

Coupling the power saw to the body may involve receiving a coupling member in a primary coupling aperture of the body. The coupling member may be for connecting to the power saw and engaging the primary coupling aperture.

Coupling the power saw to the body may involve rotatably connecting a first end of an arm to the body and a second end of the arm to the power saw.

Clamping may include engaging a first side of a top rail using a first plate and engaging a second side of the top rail using a second plate. The second side may be opposite the first side.

### BRIEF DESCRIPTION OF THE DRAWINGS

Reference will now be made, by way of example only, to the accompanying drawings in which:

FIG. 1 is a perspective view of an apparatus for operating a power saw on a fence in accordance with an embodiment;

FIG. 2 is a perspective view of a power saw for use with the apparatus shown in FIG. 1;

FIG. 3 is an exploded view of the apparatus shown in FIG. 1 in use with the power saw shown in FIG. 2;

FIG. 4 is a side view of a plate in accordance with an embodiment;

FIG. 5 is a schematic view of the apparatus shown in FIG. 1 in use;

FIG. 6 is a perspective view of an apparatus for operating a power saw on a fence in accordance with another embodiment;

FIG. 7 is a schematic view showing the motion of the apparatus shown in FIG. 6;

FIG. 8 is a top view of an apparatus for operating a power saw on a fence in accordance with another embodiment;

FIG. 9 is a perspective view of an apparatus for operating a power saw on a fence in accordance with another embodiment;

FIG. 10 is a perspective view of the swivel nut assembly of FIG. 9; and

FIG. 11 is an exploded view of the swivel nut assembly of FIG. 9.

### DETAILED DESCRIPTION OF THE EMBODIMENTS

As used herein, any usage of terms that suggest an absolute orientation, such as “top”, “front”, and “side”, are for illustrative convenience and refer to the orientation shown in an example of a particular figure. However, such terms are not to be construed in a limiting sense as it is contemplated that various components will, in practice, be utilized in orientations that are the same as, or different than those described or shown.

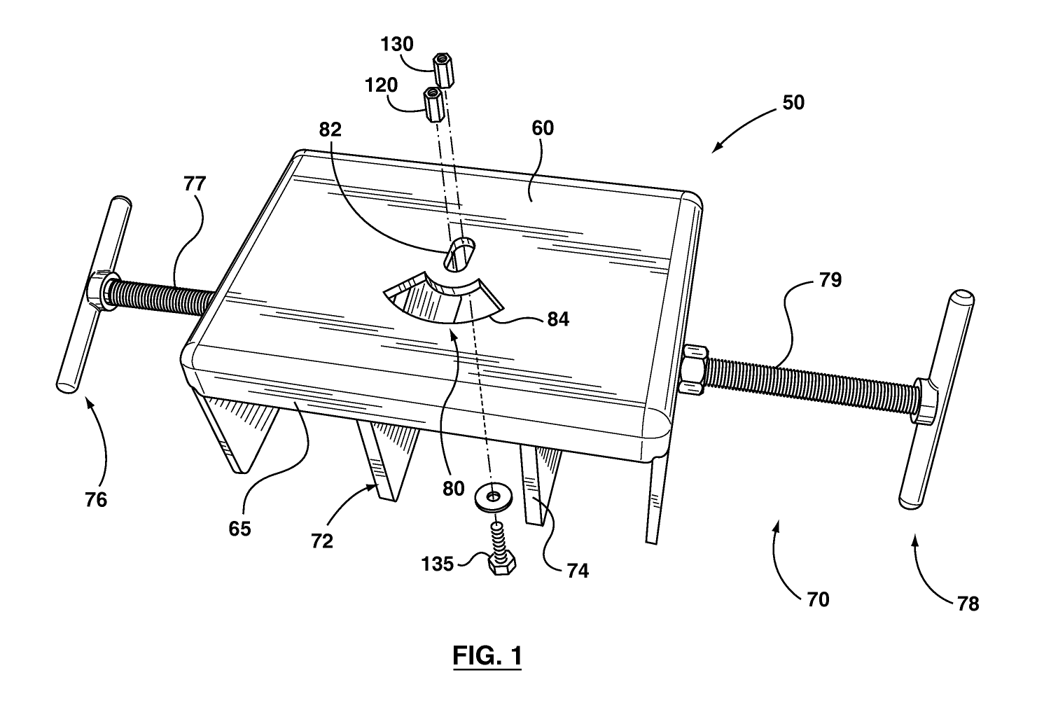

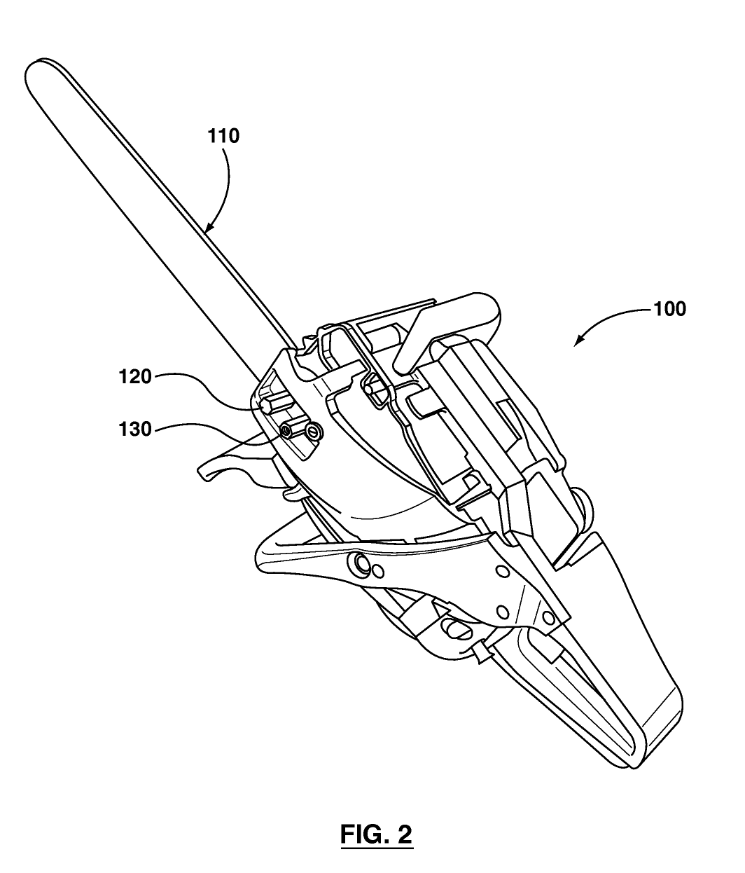

Referring to FIG. 1, an embodiment of an apparatus for operating a power saw on a fence is shown generally at 50. The apparatus 50 includes a body 60, and a clamping mechanism 70. It is to be understood that the apparatus 50 is purely exemplary and it will be apparent to those skilled in the art that a variety of apparatus for operating a power saw on a fence are contemplated. For example, the apparatus can be used on various applications with various types of fences and power saws. In particular, although one application of the present embodiment includes a fence having wooden posts and top rails, the apparatus 50 or modifications thereof can be used with other types of fences made from different materials, such as composites. Similarly, the type of power saw is not particularly limited and can include a chainsaw, circular saw, or similar. For example, FIG. 2 illustrates a power saw 100, and specifically a chainsaw, configured to be compatible with the apparatus 50. The manner by which the power saw 100 is powered is not limited and can include an internal combustion engine, an electric motor powered by a battery or alternating current source (e.g., an electric circular saw), or similar.

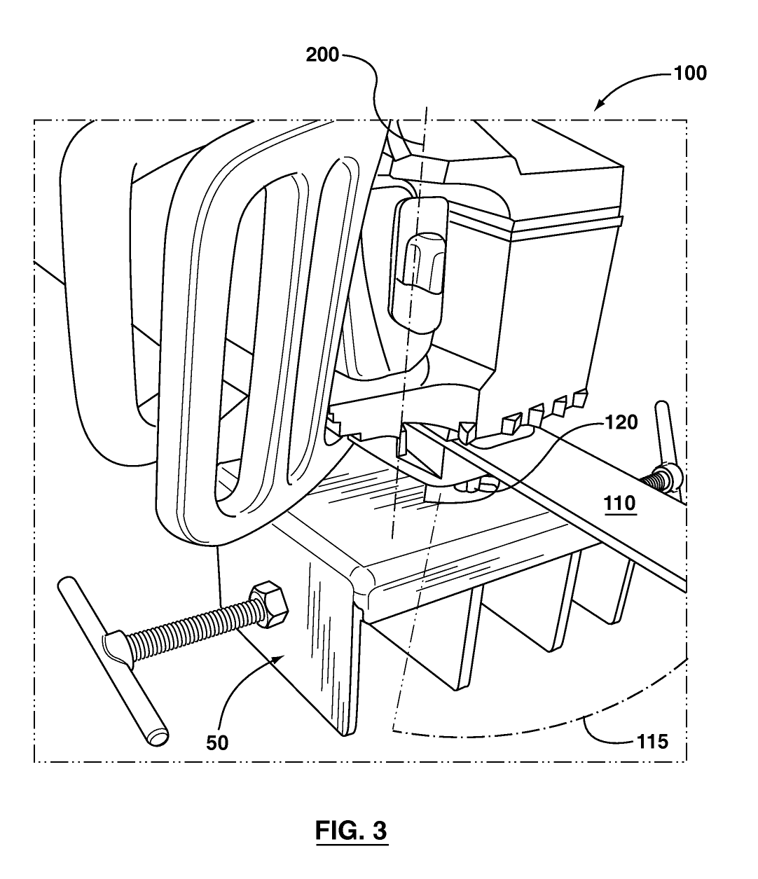

In the present embodiment, the body 60 is configured to be coupled with the power saw 100 shown in FIG. 2 via a motion limiting member 120 and a coupling member 130. The motion limiting member 120 and coupling member 130 are threaded nuts configured to replace nuts on the power saw 100 that are typically used for holding the blade 110 in place. In addition to the motion limiting member 120 and coupling member 130 holding the blade 110 to the main part of the saw 100, the coupling member 130 also secures the saw 100 to the body 60 of the apparatus 50. The internal thread of the coupling member 130 is configured to engage a bolt 135 to pivotally fasten the power saw 100 to the body 60, as shown in FIG. 3. The bolt 135 can include an attached or separate washer, or an enlarged head, to prevent the coupling member 130 from leaving the aperture 82. The motion limiting member 120 and the coupling member 130 can be after-market accessories configured to replace the two blade-securing nuts of the original power saw 100. The motion limiting member 120 and the coupling member 130 can be purchased with the apparatus 50 or purchased separately for use with the apparatus 50. It is to be appreciated with the benefit of this description that the motion limiting member 120 and the coupling member 130 are not particularly limited and can be identical to each other or different from each other.

It is to be appreciated by a person of skill in the art that the exact configuration of the power saw 100 is not particularly limited and can be modified. For example, the power saw 100 can be configured such that the motion limiting member 120 and the coupling member 130 are attached to the power saw using an adaptor or other means, such as with clips or other kinds of fasteners. In the present embodiment, the motion limiting member 120 and the coupling member 130 are part of a coupling mechanism 80 that couples the saw 100 to the apparatus 50.

In the present embodiment, the body 60 is generally configured to support the power saw 100. The body 60 can be constructed from materials that provide support for weight the power saw 100 as well as withstand the stresses and forces associated with use of the power saw 100. Accordingly, the design of the body 60 can be customized depending on the intended application and the size and weight of the power saw 100. Some examples of suitable materials for use include aluminum, steel, composites, plastics, and other materials. In the present embodiment, the body 60 is a made of steel.

The coupling mechanism 80 is generally configured for coupling the power saw 100 to the body 60 while allowing the power saw 100 to swivel relative to the body 60. In the present embodiment, the motion of the power saw 100 is constrained to be in a blade-sweep plane 115 (FIG. 3). By constraining the motion of the power saw 100 within the plane 115, the motion of the blade 110 will also be constrained to the plane 115. Accordingly, the power saw 100 attached to the body 60 can provide consistent planar cuts to a fence post relative to the position of the body 60. In the present embodiment, the coupling mechanism 80 includes the motion limiting member 120 and coupling member 130, as well as a coupling aperture 82 and a motion limiting aperture 84.

In the present embodiment, the coupling aperture 82 is configured to receive the coupling member 130. The coupling member 130 is coupled to the body 60 using the complementary bolt 135 configured to be threaded into the internal thread of the coupling member 130. With reference to FIG. 3, the coupling member 130 is constrained to be freely rotatable within the coupling aperture 82, and thus the power saw 100 is freely rotatable relative to the body 60 and about the axis 200 of the coupling member 130, such that the blade 110 is limited to sweep within the plane 115. Therefore, in the present embodiment, the coupling mechanism 80 couples the power saw 100 to the body 60 pivotally such that the power saw 100 is rotatable about the axis 200 normal to a top surface of the body 60.

In the present embodiment, the motion limiting aperture 84 is configured to receive the motion limiting member 120 of the power saw 100. The motion limiting member 120 is configured to engage the motion limiting aperture 84 to limit the range of motion of the power saw 100. As a result, the range of motion of the blade 110 is also limited in the present example. It is to be appreciated that in some applications, it is advantageous to limit the motion of the blade 110. In the present example, when the apparatus 50 is used to cut a fence post, the blade 110 is only required to move within a predefined sector that includes the fence post. Allowing the blade 110 to move any further could result in the blade 110 reaching other objects and accidentally cutting something else or damaging the blade 110. In the present embodiment, the motion limiting member 120 is configured to extend into the motion limiting aperture 84 such that the motion limiting member 120 abuts against the edges of the motion limiting aperture 84 to restrict blade motion. In the present embodiment, the motion limiting aperture 84 is arc-shaped to allow the motion limiting member 120 to freely move along the arc as the coupling member 130 rotates within the coupling aperture 82.

In addition, the sizes and relative positions of the coupling aperture 82 and the motion limiting aperture 84 are not particularly limited and can be configured to be fit a wide variety of power saws other than the power saw 100. For example, it is to be appreciated that power saws are manufactured in a wide variety of sizes depending on the application, and various manufactures make various designs. Various power saws may have various bolt spaces. Larger power saws may include larger bolts which would require the coupling aperture 82 and the motion limiting aperture 84 to be larger and/or spaced further apart. Hence, the sizes and relative positions of the coupling aperture 82 and the motion limiting aperture 84 can be selected to accommodate a reasonable range of power saws expected to be used in the fencing business.

In general terms, the coupling mechanism 80 is configured to couple the power saw 100 to the body 60 while providing a constrained motion to the power saw 100. The manner by which the power saw 100 and the body 60 are coupled is not particularly limited. For example, in the present embodiment, the power saw 100 and the body 60 are pivotally coupled to provide a motion constrained to be within a plane parallel to the surface of the body 60. However it is to be appreciated by a person of skill in the art that the coupling mechanism 80 can be substituted with other types of coupling mechanisms. Furthermore, the coupling mechanism 80 can be configured to provide a motion of the blade 110 constrained to a three-dimensional motion that is non-planar using a variety of mechanical links and joints. Accordingly, the apparatus 50 allows a user to move the blade 110 in a controlled with repeatable motion to provide consistent cuts on multiple workpieces, such as fence posts. It is to be appreciated with the benefit of this description that by providing consistent cuts, the user can use the apparatus 50 to cut multiple fence posts at desired heights above a reference point or to consistently cut substantially similar decorative patterns into fence posts.

In the present embodiment, the body 60 also includes a clamping mechanism 70. The clamping mechanism 70 is generally configured to clamp a support, such as a top rail of a fence, so that the apparatus 50 can be securely fixed in place. It is to be appreciated with the benefit of this description that the clamping mechanism 70 is not particularly limited and a person of skill in the art would recognize that the clamping mechanism 70 can be varied to accommodate the support to which the apparatus 50 is to be secured. In the present embodiment, the clamping mechanism 70 is generally configured to secure the body 60 to a top rail of a fence for use in cutting a fence post.

Accordingly, by securing the body 60 in the same relative position on a top rail, the apparatus 50 can be used to uniformly cut multiple fence posts along a fence to have a substantially equal height above the top rail without having to measure and mark each fence post individually.

Referring again to FIG. 1, the clamping mechanism 70 includes a first plate 72 and a second plate 74. The first plate 72 and the second plate 74 are configured to engage opposite sides of the top rail to secure the body 60. The first plate 72 and the second plate 74 are linearly adjustable using a first adjustment mechanism 76 and a second adjustment mechanism 78, respectively, such that the first plate 72 and the second plate 74 can move closer and further away from each other. It is to be appreciated that the clamping mechanism 70 of the present embodiment applies a frictional force to opposite sides of the top rail to secure the body 60 to the top rail. In the present embodiment, the first plate 72 and the second plate 74 include a smooth surface to engage the top rail. In other embodiments, the first plate 72 and the second plate 74 can include a textured or padded surface, a surface with spikes or teeth to improve the grip of the first plate 72 and the second plate 74 on the top rail depending on the type or requirements of the top rail. Furthermore, since the first plate 72 and the second plate 74 and independently moveable, the lateral position of the coupling mechanism 80 relative to the top rail can be adjusted during use.

In the present embodiment, the first plate 72 and the second plate 74 are generally configured to engage the top rail of a fence frictionally. The design and composition of the first plate 72 and the second plate 74 are not particularly limited. In terms of materials capable of engaging the top rail, each of the first plate 72 and the second plate 74 is constructed such that they are rigid enough to apply sufficient frictional force to support the power saw 100 on the top rail. Some examples of suitable materials used for the first plate 72 and the second plate 74 can include steel, wood, plastics, aluminum, composites, and other hard materials.

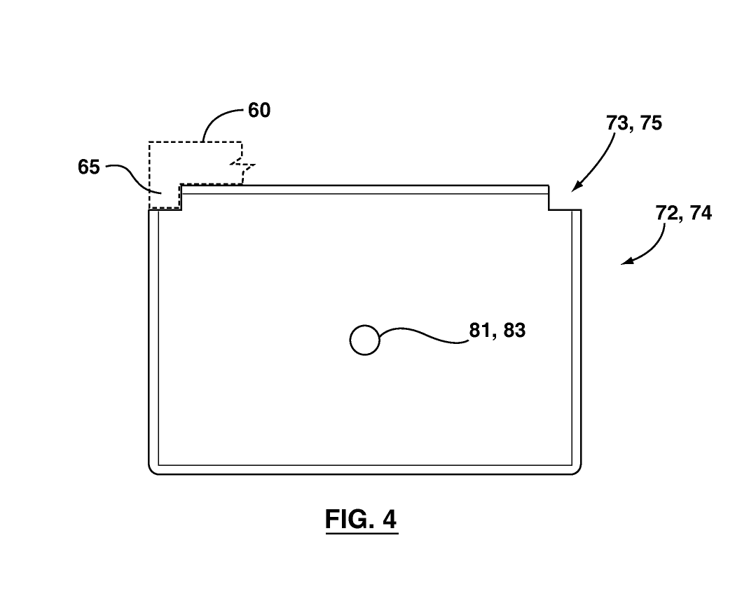

Referring to FIG. 4, the present embodiment of the first plate 72 and the second plate 74 is generally shown. It is to be understood that the first plate 72 and the second plate 74 are purely exemplary and it will be apparent to those skilled in the art that a variety of different designs can be used. In the present embodiment, the first plate 72 includes a notch 73. The notch 73 is generally configured to mate with at least a portion of the body 60 such as a notch or an edge to guide the movement of the first plate 72 relative to the body 60. In the present embodiment, the notch 73 mates with the edge 65 (FIG. 1) of the body 60. Similarly, the second plate 74 includes a notch 75. The notch 75 is generally configured to mate with at least a portion of the body 60 such as a notch or an edge to guide the movement of the second plate 74 relative to the body 60. In the present embodiment, the notch 75 also mates with the edge 65 of the body 60. It is to be re-emphasized that the structure of the first plate 72 and the second plate 74 shown in FIG. 4 are not limited and that several variations are contemplated. For example, although the notches 73 and 75 are shown on a corner of the first plate 72 and the second plate 74, it is to be appreciated that the notches 73 and 75 can be relocated to another location such as along an edge. Furthermore, in other embodiments the notches 73 and 75 can be replaced with other guiding mechanisms.

In the present embodiment, the first adjustment mechanism 76 and the second adjustment mechanism 78 are generally configured to move the first plate 72 and the second plate 74 in a linear motion to clamp a top rail of a fence when the first plate 72 and the second plate 74 frictionally engages the top rail. The first adjustment mechanism 76 and the second adjustment mechanism 78 comprise a first bolt 77 and a second bolt 79. The first bolt 77 is coupled to the first plate 72 at one end and the other end of the first bolt 77 is free to rotate. Furthermore, the first bolt 77 engages a threaded portion of the body 60 such that rotation of the first bolt 77 causes the first bolt 77 to move linearly through the threaded portion relative to the body 60. Since the first bolt 77 is coupled to the first plate 72, the movement of the first bolt 77 will consequently move the first plate 72 relative to the body 60 as well. Similarly, the second bolt 79 is coupled to the second plate 74 at one end and the other end of the second bolt 79 is free to rotate. The second bolt 79 similarly engages a threaded portion of the body 60 such that rotation of the second bolt 79 causes the second bolt 79 to move linearly through the threaded portion. Since the second bolt 79 is coupled to the second plate 74, the movement of the second bolt 79 will consequently move the second plate 74 relative to the body 60 as well. It is to be appreciated, with the benefit of this description, that the first plate 72 and the second plate 74 can be adjusted using a controlled rotation of the first bolt 77 and the second bolt 79, respectively. Furthermore, by adjusting the pitch of the first bolt 77 and the second bolt 79, the degree of fine motion and force control can be adjusted. In particular, if the top rail is constructed of a relatively soft material where a large force applied by the first plate 72 and the second plate 74 can damage the top rail, a smaller pitch on at least one of the first bolt 77 and the second bolt 79 can allow provide fine tuning for the amount of force applied to the top rail.

FIG. 4 also shows holes or recesses 81, 83 in the respective plates 72, 75 for receiving the end of the respective bolt 77, 79. Each bolt end can be rotationally mated with the respective hole 81, 83 to permit the bolt 77, 79 to rotate while pushing/pulling the plate 72, 75 to/from the fence post. This can be accomplished by a bearing at the end of the bolt 77, 79 that is press fit into the hole or recess 81, 83, one or more cotter pins, or similar.

In other embodiments, the first plate 72 is moveable as discussed above, while the second plate 74 is fixed and the second bolt 79 and respective structure is omitted.

In general terms, the clamping mechanism 70 is generally configured to secure the body 60 relative to a top rail of the fence in the present embodiment. Although one specific example of the clamping mechanism 70 is described above, the manner by which the body 60 is secured to the fence is not particularly limited. For example, in the present embodiment, although the clamping mechanism 70 uses the first plate 72 and the second plate 74 in a vertical orientation, the plates can be modified to apply force on the top and bottom of the top rail. In addition, it is to be appreciated by a person of skill in the art that more or less than two moveable plates can be used. For example, the clamping mechanism 70 can be modified to include a single moveable plate used to press the top rail against a fixed plate or another portion of the body 60. As another example of a variation, the first bolt 77 and the second bolt 79 need not be coupled to the first plate 72 and the second plate 74, respectively. Instead, the first bolt 77 and the second bolt 79 can be configured for use solely to apply pressure when tightened against the faces of the first plate 72 and the second plate 74, respectively, without being coupled to the first plate 72 and the second plate 74 when no force is applied. Furthermore, it is to be appreciated by a person of skill in the art that the first bolt 77 and the second bolt 79 are just one example mechanism for moving the first plate 72 and the second plate 74 and that others are contemplated. It is to be appreciated with the benefit of this description that by providing a clamping mechanism 70 that can be firmly attached to and detached from a top rail, the apparatus can be easily moved along a fence to where the power saw 100 is needed to make a cut.

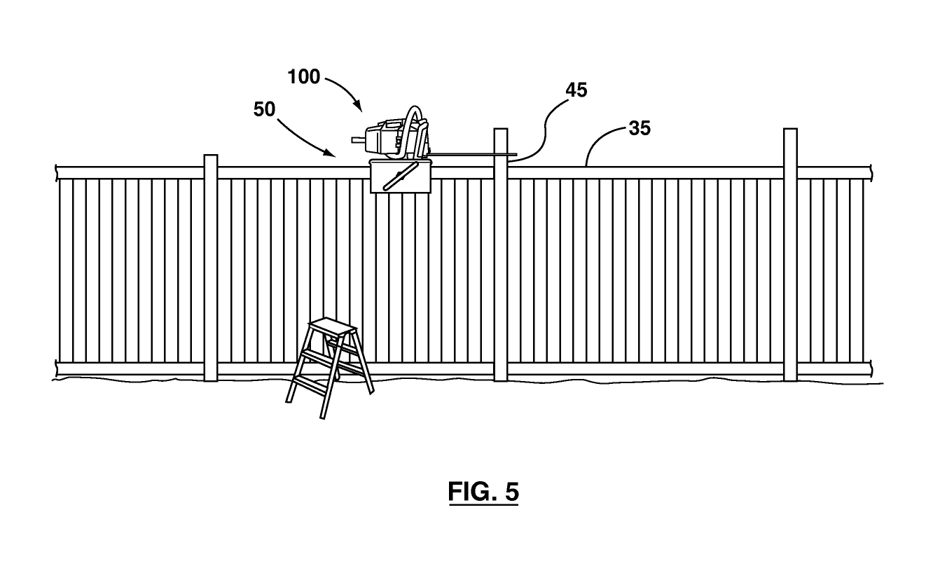

In an example of use as shown in FIG. 5, the apparatus 50 of the present embodiment is configured to clamp to a top rail 35 of a fence using the clamping mechanism 70, so that fence posts 45 can be neatly and easily trimmed. It is to be appreciated with the benefit of this description that by clamping the top rail 35 in the present embodiment, the body 60 is secured to the top rail 35 and fixed at a location relative to the fence. The apparatus 50 couples the power saw 100 to the top rail 35 and constrains the blade 110 of the power saw 100 to move within a plane for trimming the fence posts 45.

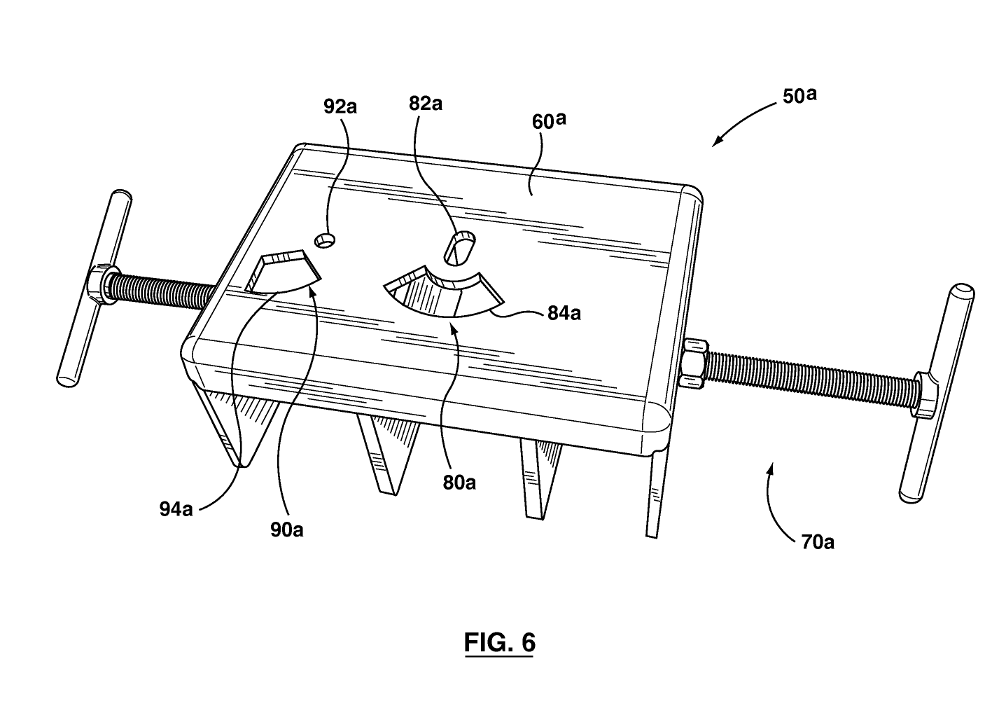

Referring to FIG. 6, another embodiment of the apparatus is generally shown at 50a. Like components of the apparatus 50a bear like reference to their counterparts in the apparatus 50, except followed by the suffix “a”. For example, the apparatus 50a includes a body 60a, and a clamping mechanism 70a.

In the present embodiment, the body 60a is generally configured to support the power saw 100. The body 60a is typically constructed from materials which can provide support for weight the power saw 100 as well as withstand the stresses and forces associated with use of the power saw 100. Accordingly, the design of the body 60a can be customized depending on the intended application and the size and weight of the power saw 100. Some examples of suitable materials for use include the materials discussed above in connection with the body 60.

The body 60a also includes a coupling mechanism 80a disposed proximate to the center point of the body 60a. The coupling mechanism 80a is generally configured for coupling the power saw 100 to the body 60a while allowing the power saw 100 to move relative to the body 60a similar to the coupling mechanism 80 discussed above. In the present embodiment, the coupling mechanism 80a constrains the motion of the power saw 100 to be in a plane such that the blade 110 can provide consistent planar cuts. It is to be appreciated that like the coupling mechanism 80, the coupling mechanism 80a is not particularly limited and can be modified to be another type of coupling mechanism constraining the movement of the power saw 100. In the present embodiment, the coupling mechanism 80a includes a coupling aperture 82a and a motion limiting aperture 84a.

In the present embodiment, the body 60a also includes an additional coupling mechanism 90a disposed at a location offset from the center point of the body 60a. In the present embodiment, the coupling mechanism 90a is identical to the coupling mechanism 80a, aside from its position and the differences discussed herein. In the present embodiment, the coupling mechanism 90a includes a coupling aperture 92a and a motion limiting aperture 94a. Similar to the coupling mechanism 80a, the coupling mechanism 90a constrains the motion of the power saw 100 to be in a plane in the present embodiment such that the blade 110 can provide consistent planar cuts.

In the present embodiment, the coupling mechanism 80a is configured to couple the power saw 100 such that the power saw 100 is rotatable about an axis normal to the surface of the body 60a passing through the coupling aperture 82a proximate to the center point of the body 60a. Furthermore, it is also to be appreciated that in the present embodiment, the coupling mechanism 90a is configured to couple the power saw 100 such that the power saw 100 is rotatable about an additional axis normal to the surface of the body 60a passing through the coupling aperture 92a, but offset from the center point of the body 60a. Although the present embodiment shows that the axes associated with the coupling mechanisms 80a and 90a are parallel, it is to be emphasized that the present embodiment is merely an example. Accordingly, several variations are contemplated. For example, the axes associated with the coupling mechanisms 80a and 90a can be non-parallel to provide angular cuts. As another example, the second coupling mechanism 90a can be structurally different from the coupling mechanism 80a, such as no longer providing pivotal motion.

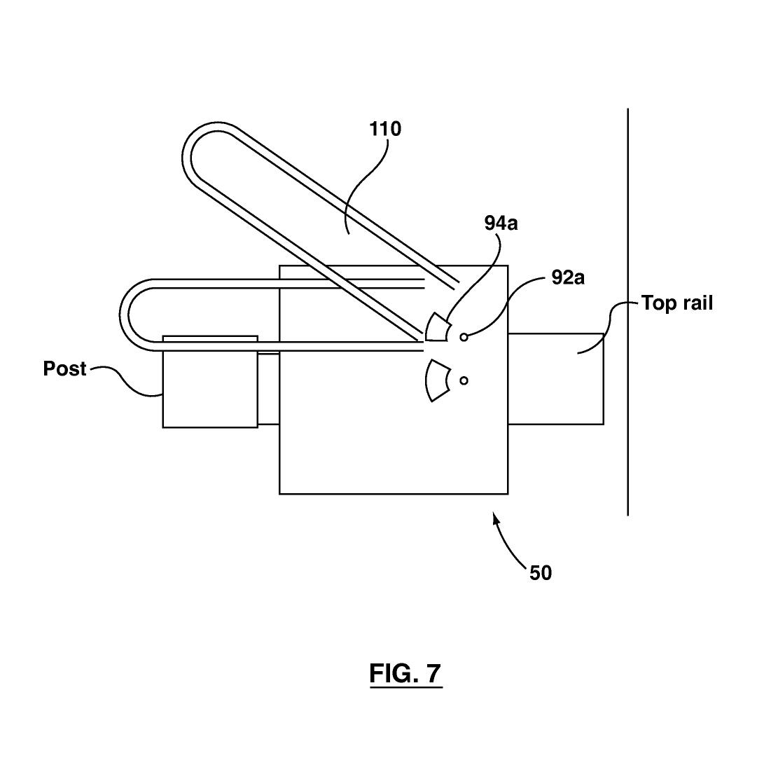

As shown in FIG. 7, the coupling mechanism 90a can be used for making decorative cuts on the side of a fence post as the blade 110. By centering the axis of rotation off center, the blade 110 of the power saw 100 can approach the fence post from a side. In contrast, when using the centered coupling mechanism 80a, the blade 110 would contact the fence post at a corner as illustrated. Decorative cuts can be made on all four side of a fence post by using the coupling mechanism 90a for gouging the front and back sides and by using the coupling mechanism 80a for gouging the lateral sides with the tip of a chainsaw blade.

Similar to the body 60, the body 60a is configured to be coupled with the power saw 100 shown in FIG. 2. In the present embodiment, the motion limiting member 120 and the coupling member 130 are configured to engage the either one of the coupling mechanisms 80a and 90a of the apparatus 50a in a manner similar to that described above. However, in other embodiments, the power saw 100 can be configured to only engage one of the coupling mechanisms 80a and 90a while the other coupling mechanisms 80a and 90a is configured to couple another power saw.

In general terms, the coupling mechanism 80a is generally configured to couple the power saw 100 to the body 60a to provide a pivotal motion to the power saw 100 about an axis in the center of the body 60a. The coupling mechanism 90a is generally configured to couple the power saw 100 to the body 60a to provide a pivotal motion to the power saw 100 about an axis offset from the center of the body 60a. It is to be appreciated that the manner by which the power saw 100 and the body 60a are coupled is not particularly limited. For example, in the present embodiment, the power saw 100 and the body 60a are pivotally coupled to provide a motion constrained to be within a plane parallel to the surface of the body 60. However it is to be appreciated by a person of skill in the art that the coupling mechanisms 80a and 90a can be substituted with other types of coupling mechanisms. Furthermore, it is to be appreciated with the benefit of this description that the coupling mechanism 80a can be used to provide a cut through the fence post or to allow for centrally etching a face of the fence post closest to the power saw 100. Alternatively, it is to be appreciated with the benefit of this description that the coupling mechanism 90a can be used to provide decorative cuts to a side of the fence post without having to cut a corner of the fence post. Accordingly, the apparatus 50a allows the blade 110 to move in at least two controlled and repeatable motions to provide consistent cuts on multiple workpieces, such as fence posts. It is to be appreciated with the benefit of this description that by providing consistent cuts, the apparatus 50a can be used to cut multiple fence posts to be of uniform height and/or to cut decorative patterns about a reference point or to consistently cut substantially similar decorative patterns into a workpiece.

In the present embodiment, the body 60a also includes a clamping mechanism 70a. The clamping mechanism 70a is generally configured to clamp a support such that the apparatus 50a can be secured to a fixed base. The manner by which the clamping mechanism 70a clamps a support is not particularly limited and can include several manners and variations such as those discussed above.

It is to be re-emphasized that the structure of the apparatus 50a shown in FIG. 6 is a non-limiting representation only. In particular, it is to be understood that the coupling mechanisms 80a and 90a are not particularly limited. For example, the coupling mechanisms 80a and 90a can be modified such that each constrains the blade 110 of the power saw 100 to different motions (e.g., linear and pivotal). As another example of a variation, the coupling mechanisms 80a and 90a can pivot about axes that are not parallel. Furthermore, the coupling mechanisms 80a and 90a need not be at a center point and offset, respectively. Instead, both of the coupling mechanisms 80a and 90a can be offset or disposed along the top rail or in any other position. Although the present embodiment shows two coupling mechanisms 80a and 90a, it is to be appreciates that the apparatus 50a can be modified to include more coupling mechanisms. For example, different coupling mechanisms can be disposed on the body 60a for different power saws which may have different complementary coupling mechanisms.

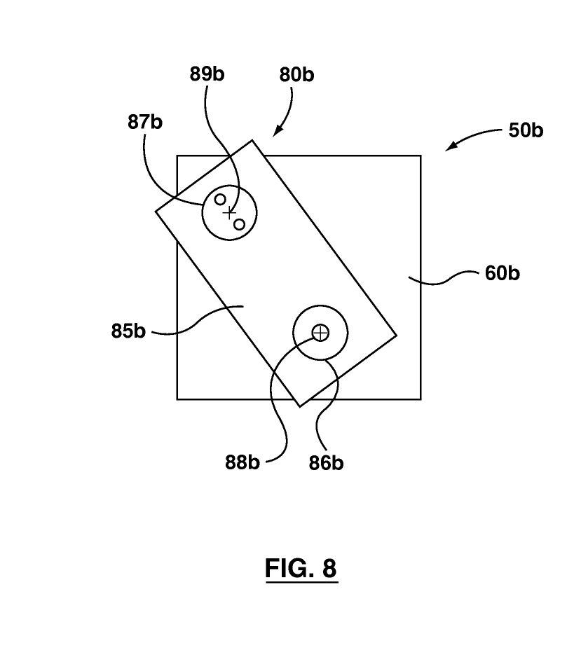

Referring to FIG. 8, another embodiment of the apparatus is generally shown at 50b as seen from above. Like components of the apparatus 50b bear like reference to their counterparts in the apparatus 50, except followed by the suffix “b”. For example, the apparatus 50b includes a body 60b, and a clamping mechanism (not shown). In the present embodiment, the clamping mechanism is not particularly limited and can include all the mechanisms discuss above.

In the present embodiment, the body 60b is generally configured to support the power saw 100 shown in FIG. 2. The body 60b is typically constructed from materials which can provide support for weight the power saw 100 as well as withstand the stresses and forces associated with use of the power saw 100. Accordingly, the design of the body 60b can be customized depending on the intended application and the size and weight of the power saw 100. Some examples of suitable materials for use include the materials discussed above in connection with the body 60.

The body 60b includes a coupling mechanism 80b. The coupling mechanism 80b is generally configured for coupling the power saw 100 to the body 60b while allowing the power saw 100 to move relative to the body 60b. In the present embodiment, the motion of the power saw 100 is constrained to be in a plane. By constraining the motion of the power saw 100 to a plane, it is to be appreciated, with the benefit of this description, that the blade 110 of the power saw 100 can provide planar cuts. Accordingly, the power saw 100 attached to the body 60b can be used to provide consistent planar cuts relative to the position of the body 60b. In the present embodiment, the coupling mechanism 80b includes an arm 85b connected to the body 60b at one end and configured to connect to the power saw 100 at the other end.

The arm 85b is rotatably connected to the body 60b using a rotatable joint or rotational bearing 86b. The structure of the rotatable joint or bearing 86b is not particularly limited and can include any mechanism that can provide the arm 85b with rotation about an axis 88b. For example, the rotatable joint 86b can include a freely rotatable bolt passing through an aperture or a ball bearing mechanism. Furthermore, the arm 85b is configured to connect rotatably to the power saw 100. In the present embodiment, the arm 85b can include a rotatable joint or rotational bearing 87b having attachment points 82b (e.g., bolts in bolt holes, threaded studs, etc.) configured to receive coupling members 130 of the power saw 100 such that the power saw 100 can rotate about the axis 89b. Thus, when the body 60b is fixed to a top rail, the arm 85b can be freely rotated with respect to the body 60b and the power saw 100 can be freely rotated about the arm 85b. This arrangement can be considered a three-bar linkage. The dual-swivel points allow the blade 110 of the power saw 100 to be controllably positioned within a wide range of motion in the blade-sweep plane to provide for a wide variety of decorative cuts.

It is to be re-emphasized that the structure of the apparatus 50b shown in FIG. 8 is a non-limiting representation only and that variations are contemplated. For example, the arm 85b can be modified to be rigidly attached to the body 60b and/or the power saw 100. It is to be appreciated that in such embodiments, the range of movement can be limited to a single connection that is rotatable. As another variation, the arm 85b can be modified to be articulated and configured to bend within a plane to increase the range of motion and be used in embodiments where the arm is not rotatably at either the connection to the body 60b or the power saw 100.

It is to be understood that many combinations, variations and subsets of the embodiments and teachings herein are contemplated. As a non-limiting example, the coupling mechanisms 80a and 90a can be modified to each include an arm similar to the coupling mechanism of 80b.

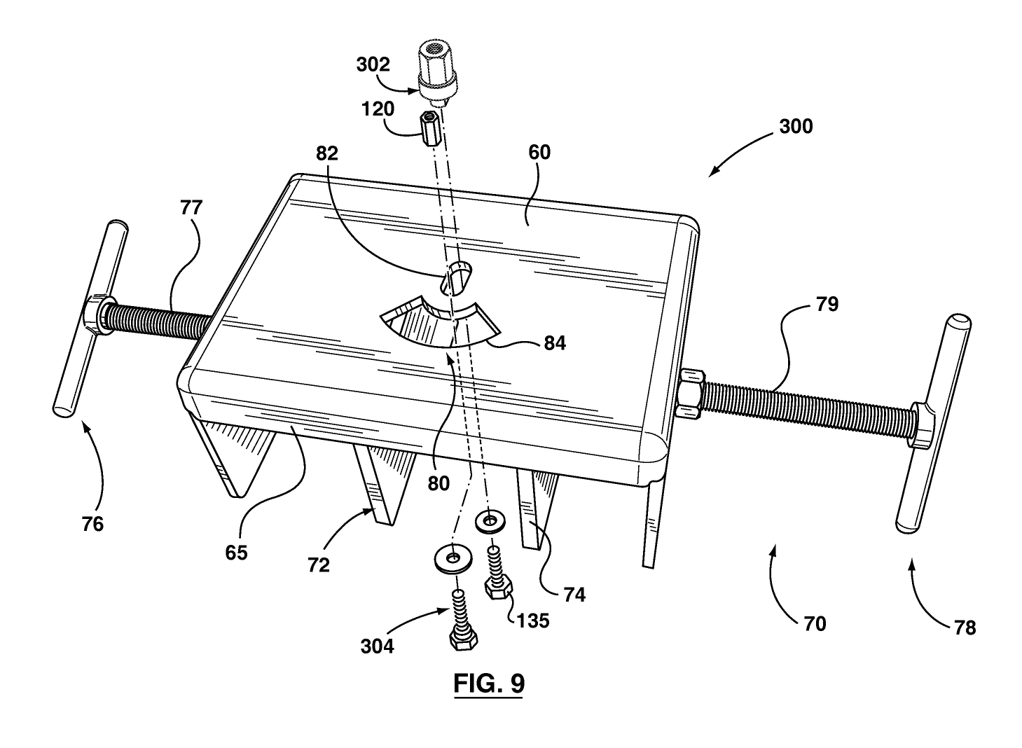

FIG. 9 shows another embodiment of the apparatus 300. This embodiment is the similar to the embodiment of FIG. 1, and only differences are discussed in detail. Like reference numerals denote like parts.

In this embodiment, a swivel nut assembly 302 is provided as the coupling member. The swivel nut assembly 302 rotatably couples the power saw to the body 60 of the apparatus 300. A lower, anchor portion of the swivel nut assembly 302 extends through the aperture 82 and engages with the bolt 135 to secure the swivel nut assembly 302 to the body 60. Flats of the lower portion engage with flats of the aperture 82 to prevent the anchor portion from rotating when the power saw is rotated. An upper, saw-attaching portion of the swivel nut assembly 302 is rotatably connected to the anchor portion and rotates with the power saw.

Also shown in FIG. 9 is a washer and bolt 304 that engages with the motion limiting member 120 to prevent the motion limiting member 120 from leaving its motion limiting aperture 84.

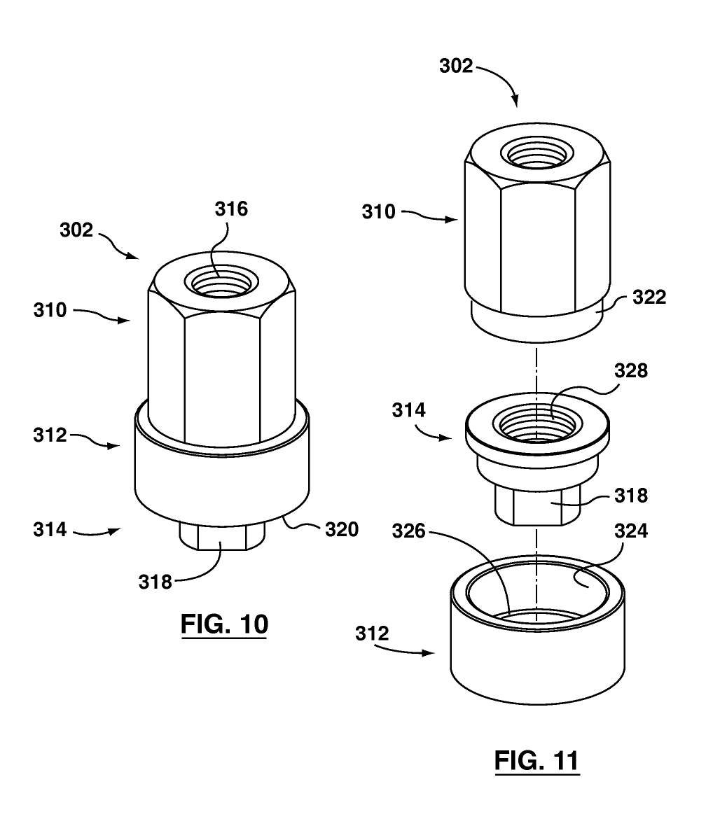

As shown in FIG. 10, the swivel nut assembly 302 includes the saw-attaching portion 310, the anchor portion 314, and a joining portion 312. The saw-attaching portion 310 is positioned above the anchor portion 314 during normal use. The saw-attaching portion 310 includes a thread 316 for mating with a rear-most stud or bolt of the power saw that, in the case of a chainsaw, holds the blade to the saw body (FIG. 2). The saw-attaching portion 310 further includes hexagonal outer surfaces for engaging with a wrench or other tool to assist in screwing the swivel nut assembly 302 to the power saw.

The anchor portion 314 includes two opposite flats 318 for abutting complementary flats of the aperture 82 (FIG. 9) to prevent rotation of the anchor portion 314 with respect to the body 60 of the apparatus 300. The part of the anchor portion 314 that extends downwards from the swivel nut assembly 302 is generally smaller in diameter than the saw-attaching portion 310.

The joining portion 312 is affixed to the saw-attaching portion 310 and rotatably captures the anchor portion 314 to permit rotation of the saw-attaching portion 310 with respect to the anchor portion 314. Alternatively, it is contemplated that the joining portion 312 can be affixed to the anchor portion 314 and rotatably capture the saw-attaching portion 310. The joining portion 312 includes an outside shoulder 320 for contact with the body 60 of the apparatus 300. The outside shoulder 320 can serve to transfer some or all of the weight of the power saw to the body 60.

With reference to FIG. 11, a lower end of the saw-attaching portion 310 includes an outside circumference 322 for mating with a complementary inside circumference 324 of the joining portion 312. The outside circumference 322 is slightly larger in diameter than the inside circumference 324 to facilitate an interference fit (e.g., press fit, friction fit, thermal expansion/contraction fit, etc.). Additionally or alternatively, welding or brazing can be used to attach the saw-attaching portion 310 and the joining portion 312.

The joining portion 312 is generally shaped as a hollow cylinder that, at its lower end, includes an inside shoulder 326 of narrowed diameter to rotatably capture the anchor portion 314.

The anchor portion 314 has a shouldered shape with a lower end having a reduced diameter that protrudes through the joining portion 312 to expose flats 318 for engagement with the body 60 of the apparatus 300. The anchor portion 314 has sufficient clearance from the joining portion 312 and saw-attaching portion 310 to permit its rotation relative to the joining portion 312 and saw-attaching portion 310. The anchor portion 314 includes an internal thread 328 for receiving the bolt 135 (FIG. 9) to secure the swivel nut assembly 302 to the body 60 of the apparatus 300.

One advantage of the swivel nut assembly 302 is that it can reduce the tendency for the threads to loosen or disengage over time. That is, the thread connection between the power saw and the swivel nut assembly 302 is isolated from the thread connection between the apparatus 300 and the swivel nut assembly 302. The risk of either or both of these two thread connections undesirably loosening is reduced because the swivel nut assembly 302 provides for relative rotation of the power saw with respect to the apparatus 300.

Advantages of the techniques discussed above include providing a simple and convenient way in which to consistently and quickly cut fence posts after the fence posts are set in the ground. Other advantages, such as providing for repeatable decorate cuts, will be apparent to those skilled in the art.

While specific embodiments have been described and illustrated, such embodiments should be considered illustrative only and should not serve to limit the accompanying claims.

What is claimed is:

1. An apparatus for operating a power saw on a fence, the apparatus comprising:
a body for supporting the power saw, the body having a primary coupling mechanism for coupling the power saw to the body and constraining movement of a blade of the power saw to be in a plane; and
a clamping mechanism connected to the body, the clamping mechanism for clamping a top rail of the fence to secure the body relative to the fence.

2. The apparatus of claim 1, wherein the primary coupling mechanism couples the power saw to the body pivotally, wherein the power saw is rotatable about a primary axis when coupled.

3. The apparatus of claim 2, wherein the primary coupling mechanism comprises a primary coupling aperture for receiving a coupling member, the coupling member for securing the power saw to the body.

4. The apparatus of claim 3, wherein the coupling member comprises a saw-attaching portion and an anchoring portion, the saw-attaching portion for fixing to the power saw, the anchoring portion for being received in the primary coupling aperture, the saw-attaching portion being rotatably connected to the anchoring portion.

5. The apparatus of claim 3, wherein the coupling member is freely rotatable within the primary coupling aperture such that the power saw is rotatable relative to the body.

6. The apparatus of claim 5, wherein the primary coupling mechanism further comprises a primary motion limiting aperture for receiving a motion limiting member connected to the power saw, the motion limiting member configured to limit the movement of the blade of the power saw by engaging the motion limiting aperture.

7. The apparatus of claim 3, wherein the primary coupling mechanism is disposed proximate to a center point of the body.

8. The apparatus of claim 7, further comprising a secondary coupling mechanism for pivotally coupling the power saw to the body, wherein the power saw is rotatable about a secondary axis when coupled.

9. The apparatus of claim 8, wherein the primary axis is parallel to the secondary axis.

10. The apparatus of claim 9, wherein the secondary coupling mechanism is offset from the center point of the body, the secondary coupling mechanism for coupling the power saw to position the blade for decorative cuts on a side of a fence post.

11. The apparatus of claim 1, wherein the primary coupling mechanism comprises an arm having a first end and a second end, the first end connected to the body and the second end connected to the power saw.

12. The apparatus of claim 11, wherein the first end is rotatably connected to the body about a first axis.

13. The apparatus of claim 12, wherein the second end is rotatably connected to the power saw about a second axis.

14. The apparatus of claim 1, wherein the clamping mechanism comprises a first plate and a second plate, the first plate for engaging a first side of the top rail and the second plate for engaging a second side of the top rail, the second side being opposite the first side.

15. The apparatus of claim 14, wherein the first plate is adjusted using a first bolt and the second plate is adjusted using a second bolt.

16. The apparatus of claim 15, wherein the first plate includes a first notch and the second plate includes a second notch, the first notch and second notch configured to mate with the body for guiding the movement of the first plate and the second plate relative to the body.

17. A method of operating a power saw on a fence, the method comprising:
clamping a body to a top rail using a clamping mechanism connected to the body, wherein clamping secures the body relative to the fence;
coupling the power saw to the body using a coupling mechanism; and
constraining movement of a blade of the power saw to be in a plane.

18. The method of claim 17, wherein coupling the power saw to the body comprises pivotally coupling the power saw to the body, wherein the power saw is rotatable about a primary axis when coupled.

19. The method of claim 18, wherein coupling the power saw to the body comprises receiving a coupling member in a primary coupling aperture of the body, the coupling member for connecting to the power saw and engaging the primary coupling aperture.

20. The method of claim 17, wherein coupling the power saw to the body comprises rotatably connecting a first end of an arm to the body and a second end of the arm to the power saw.

21. The method of claim 17, wherein clamping comprises engaging a first side of a top rail using a first plate and engaging a second side of the top rail using a second plate, the second side being opposite the first side.
